(19) United States
(12) Patent Application Publication
(10) Pub. No.: US 2025/0305994 A1
(43) Pub. Date: Oct. 2, 2025

(54) ULTRASONIC INSPECTION MACHINE FOR PERFORMING NON-DESTRUCTIVE ULTRASONIC INSPECTIONS ON WIND TURBINE BLADES

(71) Applicant: DANOBAT S. COOP., Elgoibar (GIPUZKOA) (ES)

(72) Inventors: Ivan CASTRO CASAS, Bergara (GIPUZKOA) (ES); Iratxe AIZPURUA MAESTRE, Elgoibar (GIPUZKOA) (ES); Hector GUTIERREZ, Elgoibar (GIPUZKOA) (ES)

(21) Appl. No.: 18/873,137

(22) PCT Filed: Jun. 8, 2023
(86) PCT No.: PCT/EP2023/065378

§ 371 Date: Dec. 9, 2024

(30) Foreign Application Priority Data
Jun. 10, 2022 (EP) 22382558.9

(51) Int. Cl. G01N 29/265; G01N 29/22; G01N 29/28

(52) U.S. Cl. CPC G01N 29/265; G01N 29/225; G01N 29/28; G01N 2291/2693

(57) ABSTRACT

An ultrasonic inspection machine for non-destructive testing on wind turbine blades includes a movable base, a robotic handling device arranged thereon, a robot head mounted to the handling device, and a scanning head including at least one ultrasonic testing sensor. The scanning head is arranged on the robot head capable of slidingly contacting an outer blade surface of a wind turbine blade. The machine includes a first power supply system to provide electric power to the robotic handling device, the robot head, and the ultrasonic inspection system. The inspection machine further having a blade marking device for marking positioning marks on the outer blade surface; a machine vision camera and illumination device for identifying a working window on the outer blade surface, and a distance sensor The blade marking system, machine vision camera, illumination device, and distance sensor are arranged on the robot head.

### CROSS-REFERENCE TO RELATED APPLICATIONS

This application is a 35 u.s.c. § 371 national stage patent application of PCT/EP2023/065378, filed on 8 Jun. 2023, which claims the benefit of European patent application 22382558.9, filed on 10 Jun. 2022, the disclosures of which are incorporated herein by reference in their entirety.

### TECHNICAL FIELD

The present disclosure relates to ultrasonic inspection devices for non-destructive testing of materials, particularly for wind turbine blades.

### BACKGROUND

Ultrasonic non-destructive testing (NDT) is a commonly used option for inspecting wind turbine blades. Blade structures differ between manufacturers. Many types have a main structural beam, either a box spar or shear web(s) enclosed by half-shells that transfer the aerodynamic load. Large blades are typically manufactured using composite materials such as fiber reinforced materials.

Ensuring the integrity of the generation equipment plays an important role for reliable energy production. Therefore, non-destructive test procedures are required, especially for turbine blades, which are subject to severe operational conditions due to phenomena such as lightning strikes, mechanical stress, humidity and corrosion. Non-destructive ultrasonic test techniques are commonly applied in their predictive maintenance. Wind turbine blades are complicated objects for inspection because they have a curved surface, are multi-layered, have variable thickness and are made from anisotropic materials.

Inspection machines used for ultrasonic NDT of wind-turbine blades are typically portable equipment. Ultrasonic testing of wind turbine blade using conventional portable inspection machines is burdensome and, time-taking which are drawbacks which have not been effectively solved in prior art.

### SUMMARY

A first aspect of the disclosure relates to solving the drawbacks of conventional inspection machines for ultrasonic NDT of wind-turbine blades. According to this first aspect, this disclosure provides an ultrasonic inspection machine for performing non-destructive testing on wind turbine blades comprising a movable base, a robotic handling device arranged on the movable base, a robot head mounted to the handling device, an ultrasonic inspection system comprising a scanning head comprising at least one ultrasonic testing sensor, the scanning head arranged on the robot head capable of slidingly contacting an outer blade surface of a wind turbine blade, and a first power supply system for providing electric power to the robotic handling device, the robot head and the ultrasonic inspection system, wherein the inspection machine further comprises
a blade marking device for marking positioning marks on the outer blade surface;
a machine vision camera and an illumination device for identifying a working window on the outer blade surface each working window being delimited by a positioning mark marked by the blade marking device;
a distance sensor for detecting the distance between the outer blade surface and the inspection machine;
and wherein
the blade marking system, the machine vision camera, the illumination device, and the distance sensor are arranged on the robot head;
the robotic handling device comprises a driving system for displacing the robot head vertically and horizontally with respect to each working window.

The robotic handling device is preferably a 6-axis anthropomorphic robot providing free movement of the robot head over the outer blade surface. The blade marking device may be is a stamping device.

In an embodiment, each working window is horizontally and vertically delimited by a positioning mark marked by the blade marking device and comprises sweep area defined between a first vertical line and a first horizontal line both extending from said positioning mark and a second vertical line which is opposite and parallel to the first vertical line and a second horizontal line which is opposite to the first horizontal line.

The scanning head preferably comprises an array of horizontally aligned ultrasonic testing sensors.

The ultrasonic inspection system may further comprise a water managing system including at least one water irrigation device positioned, when the irrigation device is in a water-ejecting position, above the scanning head to sprinkle water between the front surface of the scanning head and the outer blade surface such that the water flows downwards on the outer blade surface acting as a water film that sonically couples each ultrasonic testing sensor with the outer blade surface. Each irrigation device may be connected to a water supply tank by means of a water supply pumping unit.

The ultrasonic inspection system the water management system may comprise a water collecting tray positioned, when the irrigation device is in a water-ejecting position, below the scanning head to collect water dropping from the water film. The collecting tray may be connected to a water collecting tank by means of a water suction pump unit.

In an embodiment, the movable base comprises an automatically guided vehicle for moving the inspection machine hence and forth with respect to the outer blade surface along a horizontal path which comprises a plurality working windows.

The movable base may also comprise a support platform on which the robotic handing device is mounted.

The automatically guided vehicle preferably comprises a programmable electronic navigation system for moving the inspection machine along the working windows.

Further, the automatically guided vehicle preferably comprises driving wheels propelled by at least one electric motor fed by a second power supply system. In an embodiment, the second power supply system comprises at least one rechargeable battery mounted on the movable base.

### BRIEF DESCRIPTION OF THE DRAWINGS

To complete the description and in order to provide for a better understanding of the disclosure, a set of drawings is provided. Said drawings form an integral part of the description and illustrate embodiments of the disclosure, which should not be interpreted as restricting the scope of the disclosure, but just as examples of how the disclosure can be carried out. The drawings comprise the following figures:

FIG. 1 shows a front perspective view of an embodiment of the ultrasonic inspection machine according to the disclosure.

FIG. 2 shows a rear perspective view of the embodiment of the ultrasonic inspection machine shown in FIG. 1.

FIG. 3 shows a further perspective view of the embodiment of the ultrasonic inspection machine shown in FIG. 1.

FIG. 4 shows a rear perspective view of the automatically guided vehicle of the embodiment of the ultrasonic inspection machine shown in FIG. 1.

FIG. 5 shows a rear perspective view of the support platform of the ultrasonic inspection machine shown in FIG. 1.

FIG. 6 shows front perspective view of the robotic handling device shown of the ultrasonic inspection machine shown in FIG. 1.

FIG. 7 shows a front perspective view of the robot head of the ultrasonic inspection machine shown in FIG. 1.

FIG. 7A shows a schematic diagram of an embodiment of a water managing system in the ultrasonic inspection machine according to the disclosure

FIG. 8 shows a rear perspective view of the blade marking device of the robot head shown in FIG. 7.

FIG. 9 shows a front perspective view of the machine vision camera, illumination device and distance sensor.

FIG. 10 shows a partial view of the ultrasonic inspection machine shown in FIG. 1 inspecting a wind turbine blade in one stage of operation.

FIG. 11 schematically shows a side view of a wind turbine blade and a front view of the acoustic inspection machine in another stage of operation.

FIG. 11A shows enlarged view of the positioning mark shown if FIG. 11.

FIG. 12 schematically shows a view of the path of the robot head when scanning the sweep area of a scanning window.

### DETAILED DESCRIPTION OF THE DRAWINGS

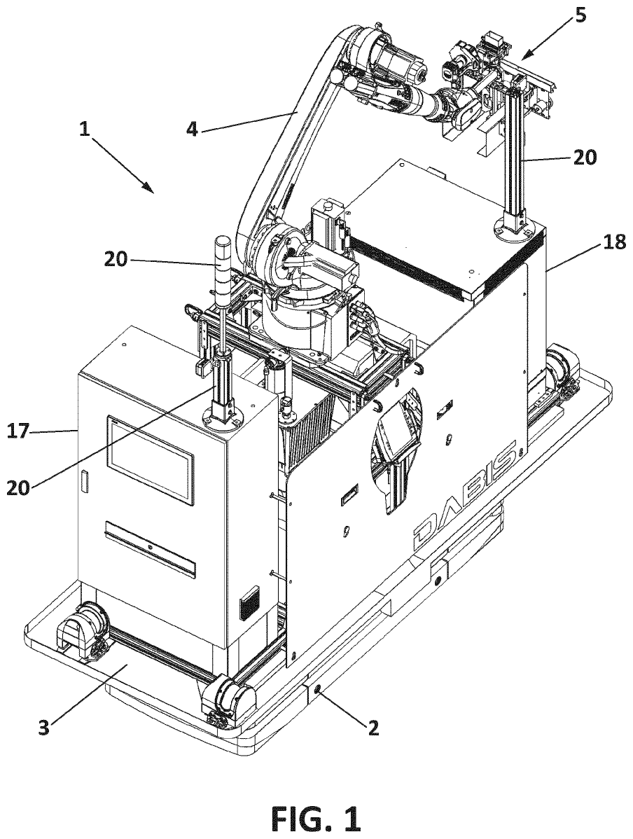

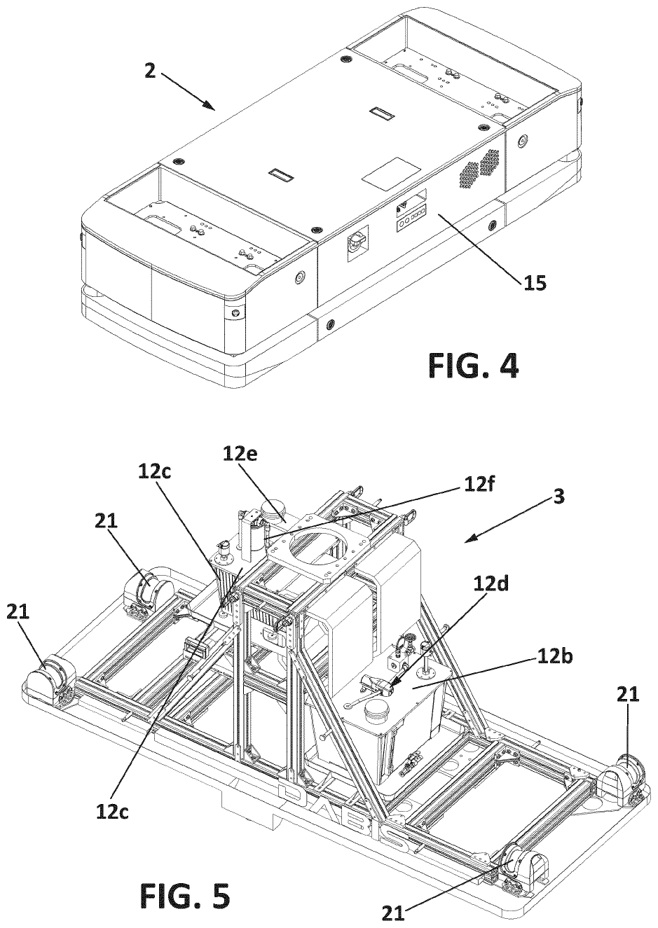

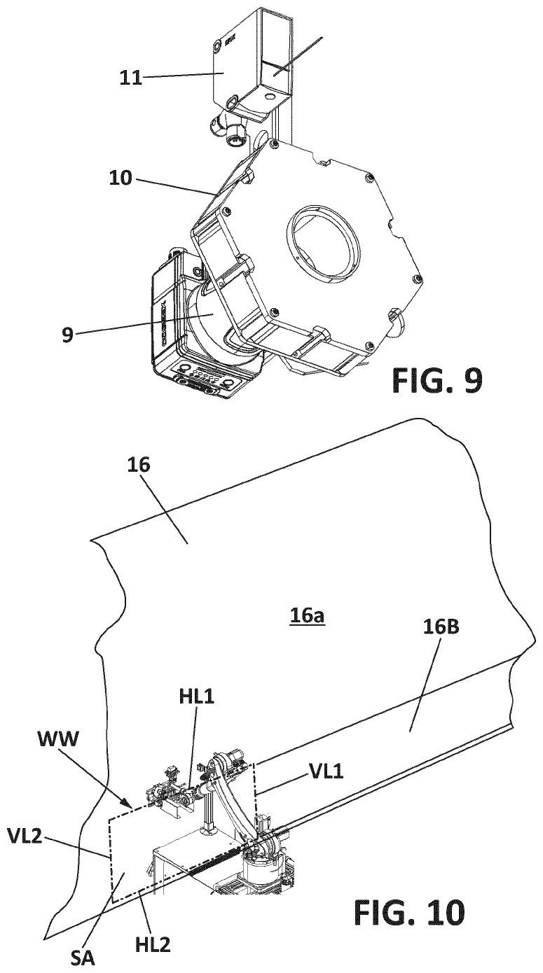

In the embodiment shown in FIGS. 1-10, the ultrasonic inspection machine -1- for performing non-destructive testing on wind turbine blades -16- comprises a movable base -2, 3-, robotic handling device -4- arranged on the movable base -2, 3-, a robot head -5- mounted to the handling device -4-, an ultrasonic inspection system housed inside a first cabinet -17- and including a scanning head -6- that comprises at least one ultrasonic testing sensor -7-. The scanning head -6- is arranged on the robot head -5- and capable of slidingly contacting an outer blade surface -16a- of a wind turbine blade -16-.

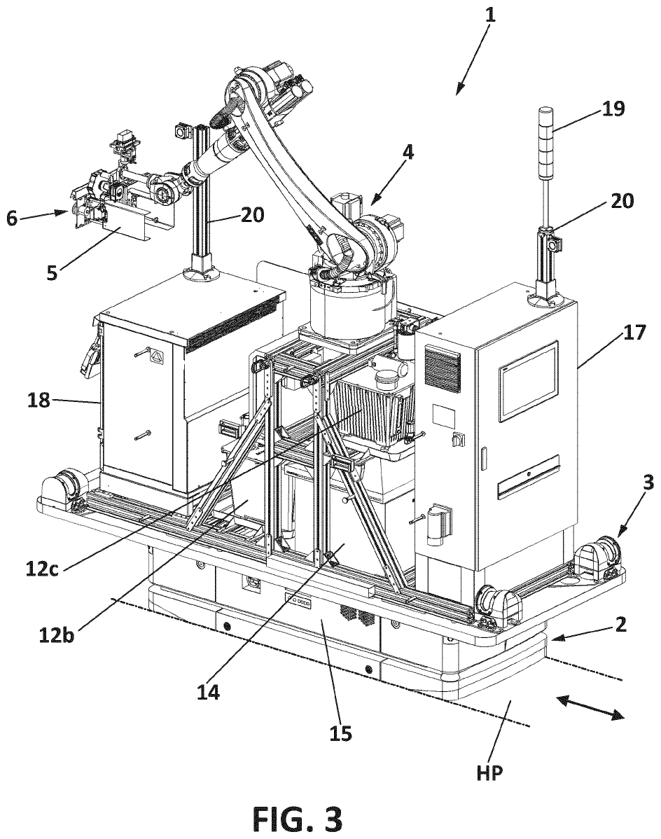

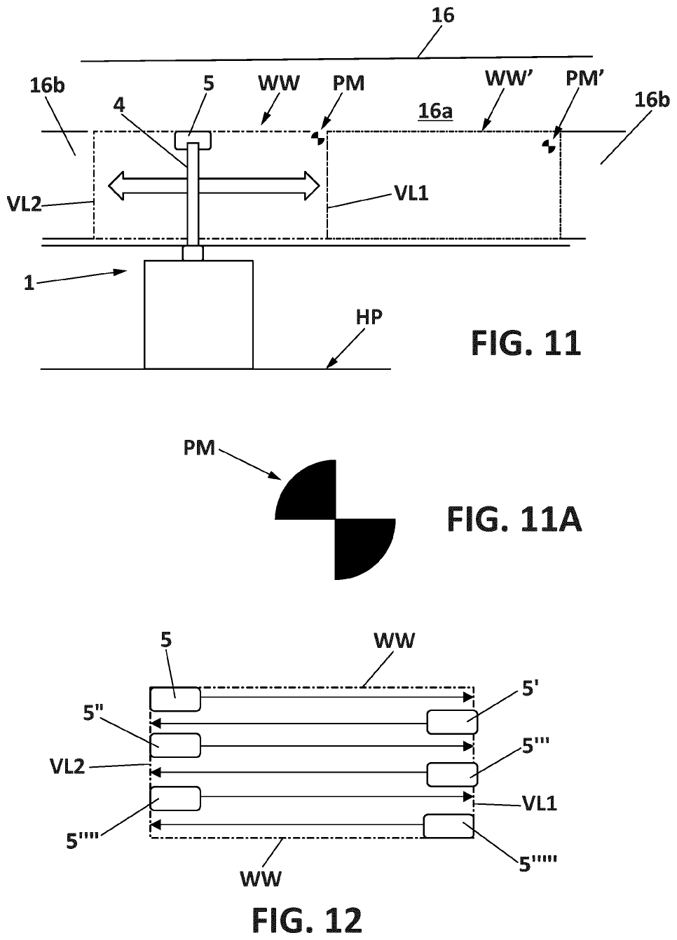

The movable base -2, 3- comprises an automatically guided vehicle -2- for moving the inspection machine -1- hence and forth with respect to the outer blade surface -16a- along a horizontal path -HP- (cf. FIGS. 3, 11), and a support platform -3- on which the robotic handing device -4- is mounted. The automatically guided vehicle -2- may be based on a per se conventional mobile platform as the KMP 1500 mobile platform of KUKA AG, Augsburg, Germany, and comprises a programmable electronic navigation system (not shown in the drawings) for moving the inspection machine -1- along the working windows -WW-. The automatically guided vehicle -2- is moved by driving wheels connected to respective electric motors and controlled by a motor control unit (not shown in the drawings). The automatically guided vehicle -2- is controlled by means of a robot controller including smartpad -3a- as for example a KUKA smartpad.

The first cabinet -17- and a second cabinet -18- are mounted on opposite end portions of a framework of the support platform -3-. The first cabinet -17- houses the ultrasonic inspection system (not shown in the drawings) whilst the second cabinet -18 - houses a robot control unit for the robotic handling device -4-.

Between the cabinets -17, 18- there is a middle framework portion with an upper part on which the robotic handling device -4- is mounted. A first power supply system comprising a number of rechargeable batteries -14- of a first power supply system, and a water managing system -12-, are mounted on the middle framework portion below the upper part of the middle framework portion, The first power supply system delivers electric power to the robotic handling device -4-, to the robot head -5- and to the ultrasonic inspection system. At the four corner portions of the support platform -3- there are arranged respective safety units -21- (cf. FIG. 5) connected to the navigation system of the ultrasonic inspection machine -1-. The safety units -21- are proximity scanners which emit beams aligned in the vertical plane to avoid possible collisions of the elements mounted on the support platform -3- with fixed and/or moving objects. An operation state traffic light -19- is mounted on the safety unit -21- mounted on the first cabinet -17- to emit luminous signals which are indicative of the operation status of the inspection machine -1- and thereby provide alerts concerning the operation status to operating personnel and other persons.

An assistance sensor -20- is mounted respectively on each of the top portions of the cabinets -17, 18-. Each of the assistance sensors -20- is also connected to the navigation system of the ultrasonic inspection machine -1-. The assistance sensors -20- detect the specific location of the component to be inspected and position of the inspection machine at each time.

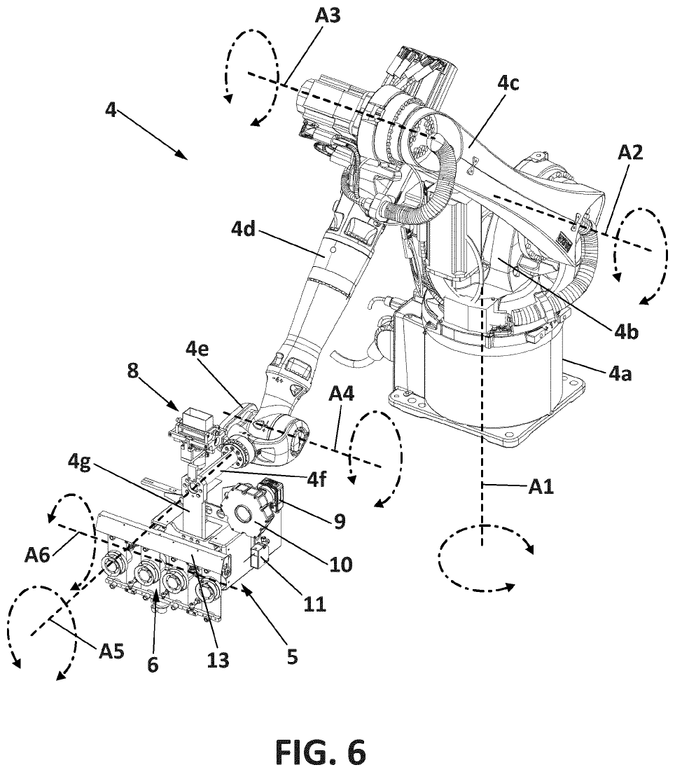

The inspection machine further comprises a blade marking device -8- (cf. FIG. 6) for marking positioning marks (PM, PM′- cf. FIGS. 11, 11A) on the outer blade surface -16a-, a machine vision camera -9- (cf. FIG. 6) and an illumination device -10- (cf. FIG. 6) for identifying a working window -WW- (cf. FIGS. 10, 11, 12) on the outer blade surface -16a-. Each working window -WW- is delimited by a positioning mark -PM -marked by the blade marking device -8-, and a distance sensor -11- for detecting the distance between the outer blade surface -16a- and the inspection machine -1-. The blade marking device -8-, the machine vision camera -9- and the illumination device -10- are also arranged on the robot head .5.

By means of the machine vision camera -9- and the illumination device -10- it becomes possible to detect the working windows (WW) due to a per se known vision algorithm which evaluates the changes in contrast on the outer blade surface -16a-, and to detect previously applied position marks to enable it to continue at the same height of the outer blade surface -16a- where it had been positioned previously. The distance sensor (11) detects the distance between the outer blade surface -16a- and the inspection machine -1- and the vision algorithm evaluates the quality of both, the position mark -PM- and the changes in contrast within the inspected material, using a machine learning algorithm based on predefined templates (FIG. 11a).

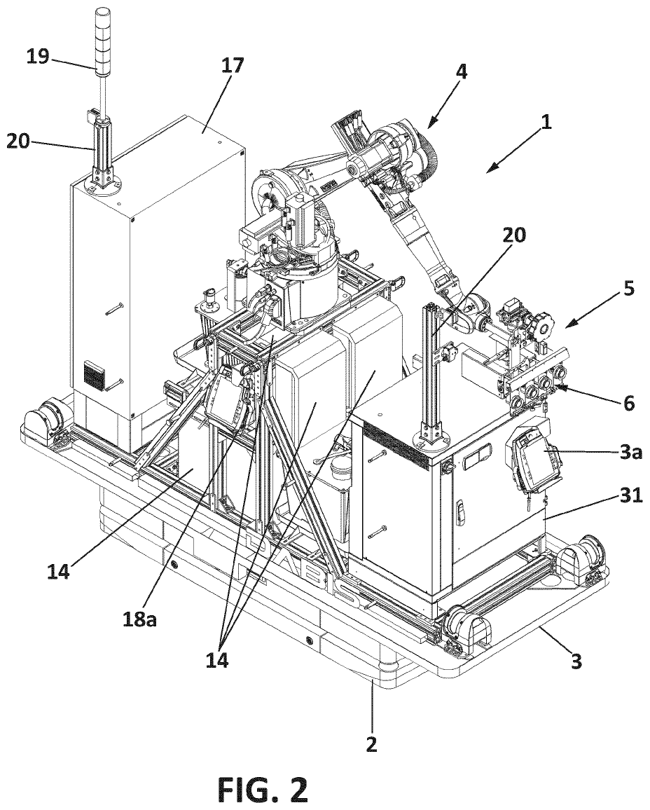

The robotic handling device -4- shown in FIG. 6, is a 6-axis anthropomorphic robot which confers free movement of the robot head -5- over the outer blade surface -16a-. The robotic handling device -4- is connected to a robot control unit housed in the second cabinet -18- which comprises a console -18a- for the operation of the anthropomorphic robot (cf. FIG. 2). The robotic handling device -4- comprises a support base (4a) fastened to the support platform -3-, a first arm -4b-, a second arm -4c-, a third arm -4d-, a fourth arm -4e-, a rod -4f- and a final connecting plate -4g-. The first arm -4b- is connected to the support base -4a- rotatably about a vertical first axis -A1-. The first arm -4c- is connected to the second arm -4c- rotatably about a horizontal second axis -A2-. The second arm -4c- is connected to the third arm -4d- rotatably about a horizontal third axis -A3-. The third arm -4d- is connected to the fourth arm -4e- rotatably about a horizontal fourth axis -A4-. The fourth arm -4e-is connected to the rod -4f- rotatably about a longitudinal fifth axis -A5-. The rod -4f- is fixed to the connecting plate -4g-, and the connecting plate -4g- is connected to the robot head -5- tiltingly with respect to a horizontal sixth axis -A6-. By this arrangement, the anthropomorphic robot and the robot head may freely adopt almost any position with respect to the blade surface -16a-. Displacement of the aforesaid elements about said axis -A1, A2, A3, A4, A5, A6- is actuated in a per se conventional manner by means of actuator devices driven by electric motors (not shown in the drawings).

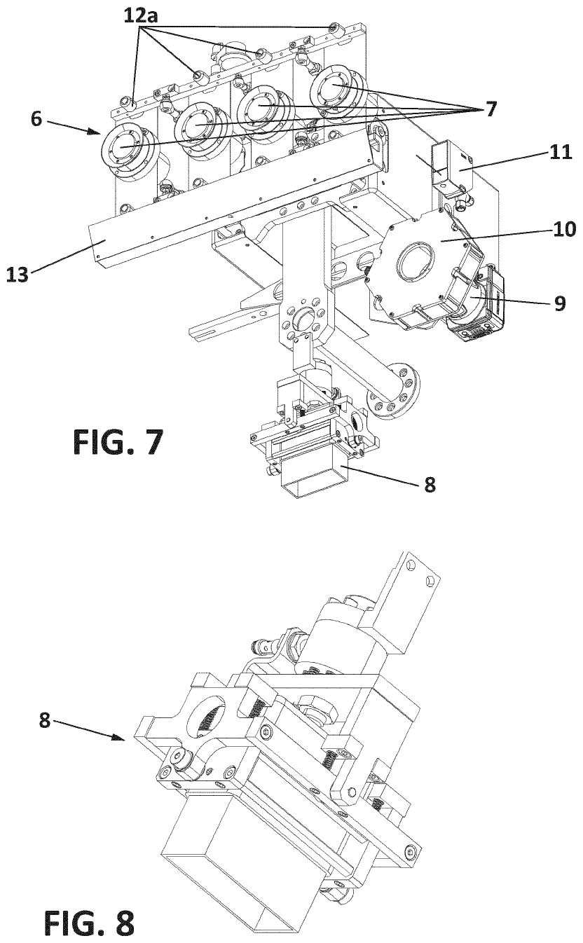

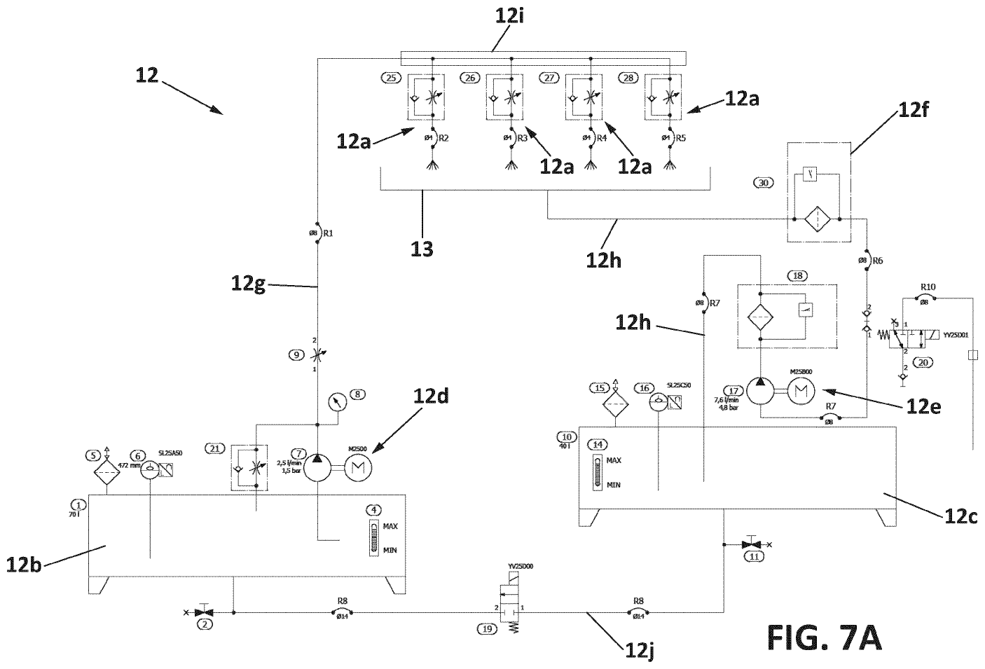

FIG. 7 depicts that the blade marking system -8-, the machine vision camera -9-, the illumination device -10-, and the distance sensor -11- are arranged on the robot head -5-. The robotic handling device -4- comprises a driving system for displacing the robot head -5- vertically and horizontally with respect to each working window -WW-. The blade marking device -8- (cf. FIG. 8) is a commercially available stamping device (Printer 40 [COLOP]) mounted in a damped linear guided metallic structure which enables stamping the position marks -PM, PM′-on the outer blade surface (16a) (cf. FIG. 11, 11A) and thereafter repositioning the automatically guided vehicle (2) to a position from where UT scanning of the wind turbine blade -16- may be continued.

The scanning head -6- is equipped with an array of horizontally aligned UT M2008 ultrasonic testing sensors -7-. These sensors allow the surface in question to be scanned using ultrasound.

The ultrasonic inspection system further comprises a water managing system -12- (cf. FIGS. 6, 7A) including four water irrigation devices -12a- connected to a distributor module -12i- positioned, when the irrigation device -12a- is in a water-ejecting position, above the scanning head -6- to irrigate water between the front surface of the scanning head -6- and the outer blade surface -16a- such that the water flows downwards on the outer blade surface -16a- acting as a water film that sonically couples each ultrasonic testing sensor -7- with the outer blade surface -16a-. Each irrigation device -12a- is connected to a water supply tank -12b- by means of a water supply line -12g- to which a water supply pumping unit -12d- is connected.

The water management system -12- also comprises a water collecting tray -13- positioned, when the irrigation device -12- is in a water -ejecting position, below the scanning head -6- to collect water dropping from the water film. The collecting tray -13- is connected to a water collecting tank -12c- by means of a water suction line -12h which is connected to a water suction pump unit -12e-. A water filter -12f- is connected to the water suction line -16h upstream the water suction pump unit -12e-.

The water supply tank -12b- and the water collecting tank -12c- are both connected to a water evacuation line -12j-

As shown in FIGS. 10, 11 and 12, each working window -WW- is a rectangular working window -WW- which is horizontally and vertically delimited based on a positioning mark -PM- (cf. FIG. 12) the applied by the blade marking device -8- and comprises a sweep area -SA-. The sweep area -SA- is defined between a first vertical line -VL1- and a first horizontal line -HL1- both extending from a corner where said positioning mark -PM- has been applied, and a second vertical line -VL2- which is opposite and parallel to the first vertical line -VL1- and a second horizontal line -HL2- which is opposite to the first horizontal line -HL1-. The horizontal and vertical extensions of each sweep area -SA- of the working window -WW- are known to the programmable control logic governing the robotic handling device -4-.

As shown in FIGS. 12, the robot head -5- is moved horizontally by the robotic handling device -4 -from one side to the other of the working window -WW- and scans a horizontal strip of the working window -WW- each time that it scans a horizontal strip. After having scanned a horizontal strip, the robot head -5- is moved vertically by the robotic handling device -4- to the vertically adjacent horizontal strip of the working window -WW-. These vertical and horizontal movements of the robot head are performed until the whole sweep area -SA- of the working window -WW- has been scanned. The robot head in its initial position when scanning the horizontal strips is identified by reference signs -5-, -5′-, -5″-, -5′″, -5″″ - and -5′″″- respectively.

Once a working window -WW- has been scanned, the robot head -5- rotates 90 degrees around A4 robot axis to allow stamping the positioning mark -PM- After the stamping process, the robot head -5- comes back to the original position rotating −90 degrees around A4 robot axis and it displaces horizontally (cf. FIG. 11) until detecting a subsequent positioning mark -PM′- on the basis of which a subsequent working window -WW′- is determined, and scanning of the whole sweep area -SA- of the working window -WWi- has been scanned according to the steps described here before with respect to the previous working window -WW-.

In this text, the terms first, second, third, etc. have been used herein to describe several devices, elements or parameters, it will be understood that the devices, elements or parameters should not be limited by these terms since the terms are only used to distinguish one device, element or parameter from another. For example, the first axis could as well be named second axis, and the second axis could be named first axis without departing from the scope of this disclosure.

In this text, the term “comprises” and its derivations (such as “comprising”, etc.) should not be understood in an excluding sense, that is, these terms should not be interpreted as excluding the possibility that what is described and defined may include further elements, steps, etc.

On the other hand, the disclosure is obviously not limited to the specific embodiment(s) described herein, but also encompasses any variations that may be considered by any person skilled in the art (for example, as regards the choice of materials, dimensions, components, configuration, etc.), within the general scope of the disclosure as defined in the claims.

1. An ultrasonic inspection machine for performing non -destructive testing on wind turbine blades comprising
a movable base,
a robotic handling device arranged on the movable base,
a robot head mounted to the handling device,
an ultrasonic inspection system comprising a scanning head comprising at least one ultrasonic testing sensor, the scanning head arranged on the robot head configured to slidingly contacting an outer blade surface of a wind turbine blade,
a first power supply system for providing electric power to the robotic handling device, the robot head and the ultrasonic inspection system,
wherein the inspection machine further comprises a blade marking device for marking positioning marks on the outer blade surface;
a machine vision camera and an illumination device for identifying a working window on the outer blade surface each working window being delimited by a positioning mark (PM) -marked by the blade marking device;
a distance sensor for detecting the distance between the outer blade surface and the inspection machine;
and in that
the blade marking system, the machine vision camera, the illumination device, and the distance sensor are arranged on the robot head;
the robotic handling device comprises a driving system for displacing the robot head vertically and horizontally with respect to each working window.

2. The ultrasonic inspection machine according to claim 1, wherein the robotic handling device is a 6-axis anthropomorphic robot providing free movement of the robot head over the outer blade surface.

3. The ultrasonic inspection machine according to claim 1, wherein the blade marking device is a stamping device.

4. The ultrasonic inspection machine according to claim 1, wherein each working window is horizontally and vertically delimited by a positioning mark marked by the blade marking device and comprises sweep area defined between a first vertical line and a first horizontal line both extending from said positioning mark and a second vertical line which is opposite and parallel to the first vertical line and a second horizontal line which is opposite to the first horizontal line.

5. The ultrasonic inspection machine according to claim 1, wherein the scanning head comprises an array of horizontally aligned ultrasonic testing sensors.

6. The ultrasonic inspection machine according to claim 1, wherein the ultrasonic inspection system further comprises a water managing system including at least one water irrigation device positioned, when the irrigation device is in a water-ejecting position, above the scanning head to sprinkle water between the front surface of the scanning head and the outer blade surface such that the water flows downwards on the outer blade surface acting as a water film that sonically couples each ultrasonic testing sensor with the outer blade surface.

7. The ultrasonic inspection machine according to claim 6, wherein the ultrasonic inspection system the water management system comprises a water collecting tray positioned, when the irrigation device is in a water-ejecting position, below the scanning head to collect water dropping from the water film.

8. The ultrasonic inspection device according to claim 6, wherein each irrigation device is connected to a water supply tank by a water supply pumping unit.

9. The ultrasonic inspection machine according to claim 7, wherein the collecting tray is connected to a water collecting tank by a water suction pump unit.

10. The ultrasonic inspection machine according to claim 1, wherein the movable base comprises an automatically guided vehicle for moving the inspection machine hence and forth with respect to the outer blade surface along a horizontal path which comprises a plurality working windows.

11. The ultrasonic inspection machine according to claim 10, wherein the movable base comprises a support platform on which the robotic handing device is mounted.

12. The ultrasonic inspection machine according to claim 10, wherein the automatically guided vehicle comprises a programmable electronic navigation system for moving the inspection machine along the working windows.

13. The ultrasonic inspection machine according to claim 10, wherein the automatically guided vehicle comprises driving wheels propelled by at least one electric motor fed by a second power supply system.

14. The ultrasonic inspection machine according to claim 13, wherein the second power supply system comprises at least one rechargeable battery mounted on the movable base.
